(19) United States
(12) Patent Application Publication
(10) Pub. No.: US 2007/0217487 A1
(43) Pub. Date: Sep. 20, 2007

(54) Data Transfer Between Several Transmitters and One Receiver

(76) Inventors: Hans-Christian Mueller, Gelsenkirchen (DE); Dieter Greifendorf, Duisburg (DE); Martin Loercks, Duisburg (DE); Alexander Coers, Dortmund (DE); Andreas Jansen, Essen (DE); Rainer Kokozinski, Oberhausen (DE); Markus Holzapfel, Duisburg (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/626,933

(22) Filed: Jan. 25, 2007

(30) Foreign Application Priority Data
Mar. 17, 2006 (EP) 06005527.4

(51) Int. Cl. H04B 1/38; H04L 27/00

(52) U.S. Cl. 375/219; 375/259

(57) ABSTRACT

The present is a description of a method for transferring data between at least two transmitters and one receiver having repeatedly transferring first identical data from a first one of the transmitters to the receiver in a first sequence and repeatedly transferring second identical data from a second one of the transmitters to the receiver in a second sequence. The number of repetitions in the first sequence and the number of repetitions in the second sequence are equal to or greater than the number of transmitters, and the first and second sequences are different to each other. In this way a data transfer can be realized with less expenditure.

### CROSS-REFERENCE TO RELATED APPLICATION

This application claims priority from European Patent Application No. 06005527.4, which was filed on Mar. 17, 2006, and is incorporated herein by reference in its entirety.

### BACKGROUND OF THE INVENTION

1. Field of the Invention

The present invention relates to the data transfer between several transmitters and one receiver.

2. Description of the Related Art

In each data transfer there are physical connecting paths, so-called channels, over which individual apparatuses communicate with one another. The manner in which the individual apparatuses utilize and occupy these channels is denoted as channel access method and can be realized in different ways. In principle, the different access methods can be divided into two categories. In the first category the access to the channel is effected in a probabilistic way, and in the second category in a deterministic way. The ALOHA method, the CSMA/CD method, the token-ring and the token-bus method as well as the TDMA multiplex method are conventional access methods in which channel access is performed separate in time.

The ALOHA method is based on the fact that each apparatus may access the channel and transmit at any time. After each transmission process the apparatus awaits a response which is performed on a separate channel. If two apparatuses transmit at the same time, a data collision will occur, so that the data blocks will be corrupt and thus no response will be transmitted over the return channel. If an apparatus receives a response, it can transmit further data over the channel. If, due to a data collision, the apparatus receives no response, then each apparatus will wait for a different period of time generated by a random generator and will subsequently transmit the data once more. The introduction of time slots resulted in an improvement of the data throughput in the ALOHA method. Each apparatus may begin transmitting its data only at the beginning of a fixed time interval. All apparatuses are synchronized by an apparatus provided for this purpose which periodically transmits time packets to which all other apparatuses synchronize themselves.

The CSMA/CD (Carrier Sense Multiple Access with Collision Detection) method is described in the standards: IEEE 802.3, ISO 8802/3, DIN-ISO 8802-3. In this method all apparatuses have equal rights to access the transfer channel. Before an apparatus may transmit its data over the channel, it must first check whether there already is a data transfer taking place on the channel. Only when it determines that the channel is free, will it transmit its data. During the transmission process it continues to listen to the channel so as to determine if not another transmitter has begun its data transfer at the same time so that a data collision would occur nevertheless.

If a transmitter detects a collision of its data packet with another data packet, i.e. if it detects that data other than those transmitted by it are received, it will cancel the data transmission and transmit a JAM signal. This signal ensures that all transmitters and receivers involved in a data transfer will also register the occurrence of the collision and cancel processing the current data packet. This method is frequently applied in logical bus networks such as the Ethernet.

In the token-ring method the apparatuses are connected such that they form a ring-shaped structure. If no apparatus transmits payload data on the channel, a free-token message signaling an unoccupied channel will circulate the ring. It is forwarded from one apparatus to the next. An apparatus cannot transmit data until it receives the free-token message. It appends its data to this message so that the latter now automatically becomes a busy-token message. This data packet continues to be forwarded from one apparatus to the next until it has arrived at its receiver. The receiving apparatus confirms receiving the data packet through an acknowledgement message which is sent onto the ring again along with the token and finally arrives back at its sender. This apparatus in turn now sends a free token onto the ring. In order to avoid one-sided channel utilization by a single apparatus, the period of the transmission authorization is generally limited.

The token-bus method is specified in standard IEEE 802.4. In this method access to the network is also controlled by the forwarding of a token message. However, in contrast to the token-ring method the network is not arranged in the form of a ring, but set up in a bus and/or tree structure in which addresses are allocated to all apparatuses, the addresses allowing unambiguous identification thereof. Each token is forwarded from one apparatus to the one with the next lower address. The apparatus with the lowest address then passes the token to the apparatus with the highest address. This method is applied, for example, in industrial automatization.

In the time division multiple access method the transmission time is divided into time slots which are repeated periodically. In operation, a time slot for data transmission is allocated to each connection between two apparatuses. A data collision of different apparatuses is inhibited due to the time slot allocation.

The above access methods which guarantee the error-free transmission of data packets have a number of disadvantages, such as the necessity of time-synchronizing all apparatuses so that the apparatuses can access a channel separate in time, the necessity for the apparatuses to determine whether a given channel is free at a given time or being able to transmit and/or receive a reply as to the proper reception of a data packet. Error-free transmission of data therefore requires either a controlling apparatus which guarantees time synchronization, or the transmitter and/or receiver require additional hardware for receiving and/or transmitting data. This renders data transmission complex and expensive, as in both cases the apparatuses must have a hardware at their disposal which can receive data even if payload data are not to be received but solely transmitted.

### SUMMARY OF THE INVENTION

It is the object of the present invention to provide a method and a device for transferring data between several transmitters and one receiver so that a secure data transfer can be realized with less expenditure.

In accordance with a first aspect, the present invention provides a method for transferring data between at least two transmitters and one receiver, including the steps of a) repeatedly transferring first identical data from a first one of the transmitters to the receiver in a first sequence; and b) repeatedly transferring second identical data from a second one of the transmitters to the receiver in a second sequence, wherein a number of repetitions in the first sequence and a number of repetitions in the second sequence are equal to or greater than the number of transmitters and the first and second sequences are different to each other.

In accordance with a second aspect, the present invention provides a device for transferring data to a receiver, including a first transmitter implemented to transfer first identical data to the receiver in a first sequence; and a second transmitter implemented to transfer second identical data to the receiver in a second sequence, wherein a number of repetitions in the first sequence and a number of repetitions in the second sequence are equal to or greater than the number of transmitters and the first and second sequences are different to each other.

In accordance with a third aspect, the present invention provides a computer program with a program code for performing the above-mentioned method when the computer program runs on a computer.

The present invention is based on the finding that a method and a device will avoid the above-mentioned disadvantages of the prior art if each transmitter transmits a given data packet repeatedly, however with and/or in an identifier, i.e. pattern or time sequence, specific for each transmitter. When the time sequence is suitably selected and furthermore the number of repetitions corresponds to at least the number of transmitters, it can be guaranteed that within a period of time the receiver receives from each transmitter at least one data packet which is not interfered with by another transmitter. In other words, for each transmitter at least one of the repeatedly transmitted versions of the data packet of this transmitter reaches the receiver without disturbance or interference by the repeatedly transmitted versions of the data packets of the one or more other transmitters.

### BRIEF DESCRIPTION OF THE DRAWINGS

A preferred embodiment of the present invention refers to the accompanying drawings, in which:

FIG. 1 shows a block diagram of an exemplary arrangement comprising three transmitters and one receiver in which the present invention can be implemented; and

FIG. 2 shows graphs for illustrating the data transfer scheme in the arrangement of FIG. 1 according to an embodiment of the present invention.

### DESCRIPTION OF THE PREFERRED EMBODIMENTS

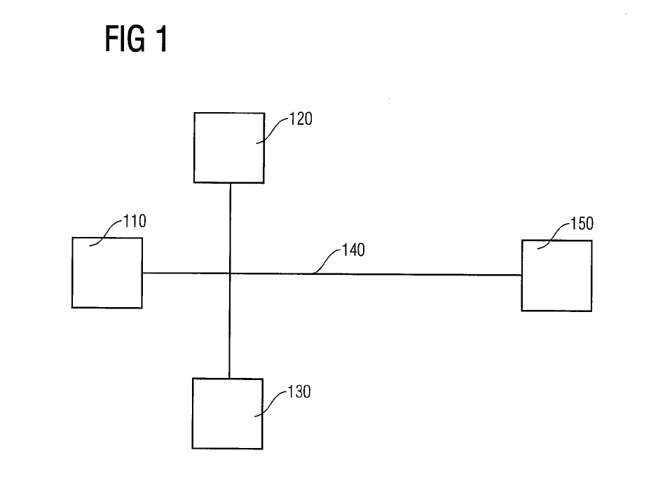

FIG. 1 shows an exemplary arrangement comprising a first transmitter 110, a second transmitter 120 and a third transmitter 130 which are coupled via a common transfer channel 140 to a receiver 150 in order to transfer data thereto, wherein the common transfer channel 140 is, for example, a line or a wireless transfer channel. For example, in the last-mentioned case, the data is transferred to the receiver over transfer channel 140 by means of electromagnetic waves such as radio waves or sound waves, such as ultrasonic waves, at a certain frequency, i.e. in a channel. Here, the common data path 140 is made such that a simultaneous arrival of transmitted data from different ones of transmitters 110-130 at receiver 150 may lead to a mutual interference and/or interference of the reception of this data, so that in this case the receiver does not receive the data of any of the transmitters correctly or the reception would be possible only at increased expenditure.

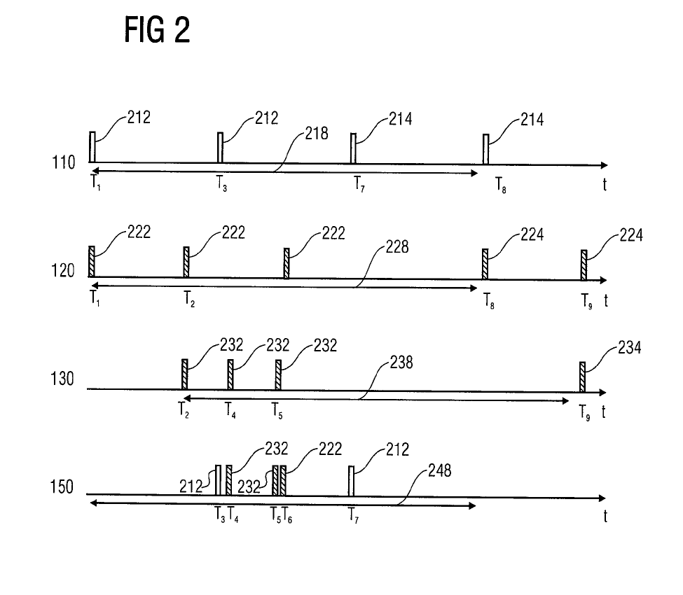

In the following the data transfer scheme in the arrangement of FIG. 1, which in the following will also be denoted as the nonius method, will be explained in greater detail referring to FIG. 2. This nonius method, as the subsequent discussion will show, makes it possible to guarantee secure data transfer from the transmitters 110-130 to the receiver 150 even without these transmitters 110-130 being synchronized. More specifically, no hardware required for receiving data such as acknowledgement messages and the like will be required on the transmitter side.

However, before a special scenario of transferring data from the transmitters 110-130 to the receiver 150 will be described referring to FIG. 2, an outline of the nonius method in general will be given below. In the nonius method each transmitter 110-130 transfers its data packets to be sent in a pattern predetermined for the respective transmitter 110-130. These patterns will be illustrated more closely in the explanation of FIG. 2 as stated below and include repeatedly transferring one and the same data packet in a certain sequence and/or an identifier with a certain sequence period, whereupon a next data packet is transferred in a next sequence. Therefore, the same payload data are always transmitted during the transmission of a pattern. When transmitting the pattern sequence is completed, the pattern sequence is repeated with the next payload data. In the embodiment of FIG. 2 the patterns are predetermined such that the pattern sequences and/or the series of time intervals between data transfers are different for all transmitters. The period of a pattern sequence may be different for all transmitters, whereas, however, in the special embodiment of FIG. 2 described in the following they are the same. The shortest pattern sequence is denoted as transmit window and identifies the period of time in which at least one packet from each transmitter 110-130 reaches receiver 150 without having experienced a collision with another transmitter packet.

FIG. 2 shows an exemplary scenario in which transmitters 110-130 each intend to transmit a data packet to receiver 150. Here, the topmost graph shows the timeline of the transmit performance of transmitter 110, the second graph from the top shows the timeline of the transmit performance of transmitter 120, the third graph from the top shows the timeline of the transmit performance of transmitter 130 and finally the fourth graph shows the timeline of the arrival of uninterfered data packets at receiver 150, i.e. the arrival of individual data packets from the transmitters 110-130 without the simultaneous arrival of another data packet. In each case the time t is plotted along the horizontal axis. It is understood that in FIG. 2 the run-time periods were neglected for better understanding, whereas, however, the subsequent description may be applied easily also in the case of different run-time periods.

According to the example of FIG. 2, transmitters 110-130 exemplary transfer data packets of a length of 50 ms. Transmitters 110-130 transmit the data packets in predetermined patterns so as to guarantee exemplarily in this case that within a period of six seconds at least one data packet from each transmitter 110-130 is transmitted without being destroyed by another transmitter.

In order to achieve this transmitters 110-130 transmit their data packets repeatedly with time intervals between the individual repetitions or transmission processes, which are selected exemplarily in FIG. 2 for the individual transmitters 110-130 as follows and as shown in FIG. 2. Transmitter 110, for example, transmits a current data packet 212 at a time T₁ and repeats the transfer of this data packet 212 at a time T₃ with a time interval of exemplarily two seconds and after that again at a time T₇ with a time interval of two seconds as well. Transmitter 110 carries out the transfer of the next data packet 214 at a time T₈, which here all in all exemplarily is six seconds after the first transfer of the preceding data packet 212 at time T₁.

Although not shown in FIG. 2, transmitter 110 also repeats the transfer of data packet 214 twice with an interval between the repetitions of an exemplary two seconds while carrying out the transfer of the next data packet in turn twelve seconds after time T₁ etc. Accordingly, transmitter 110 transmits subsequent data packets 212, 214 in pattern sequences of a length of six seconds, wherein the period between the transfers of one and the same data packet 212 is two seconds each time and the period of the last transfer of this data packet to the first transfer of the next data packet 214 is two seconds as well.

Correspondingly, transmitter 120 transmits its data packets 222 and 224 in a predetermined pattern sequence as well, wherein, however, the time intervals between the transfers of one and the same data packet 222 are 1.5 seconds each time and the time interval of the last repeated transfer of this data packet 222 to the transfer of the next data packet 224 is three seconds so that the pattern sequence length of transmitter 120 is altogether six seconds as well. Exemplarily, the pattern sequences of transmitters 110 and 120 are shown synchronized to each other in FIG. 2 such that the first transfer of data packet 212 and 222 of both transmitters takes place at the same time, i.e. time T₁, which is, however, not necessary as becomes apparent by means of transmitter 130.

Transmitter 130 transmits its series of data packets 232 and 234 in a predetermined pattern sequence of a period of six seconds as well. However, the pattern sequences are phase-shifted to those of transmitters 110 and 120. FIG. 2 shows the exemplary case that transmitter 130 carries out the transfer of data packet 232 for the first time at the time T₂. Its pattern sequence is such that the period between the transfers of one and the same data packet 232 is 0.7 seconds each time, while the time interval between the last transfer of this data packet and the data transfer of the next data packet 234 is 4.6 seconds.

As can be seen from viewing the topmost three graphs together, some of the data transfers of the data packets 212-234 by the different transmitters 110-130 take place at the same time, which may lead to an interfered reception at receiver 150, such as the transfer of the data packets 212, 222 at the time T₁ as well as the transfer of the data packets 214, 224 at the time T₈ and of the data packet 224 and 234 at the time T₉ as well as the data packets 222, 232 at the time T₂. As a whole, however, the time intervals between the transfers and/or the pattern sequences are selected such that, even if the time at which each transmitter 110-130 begins its pattern sequence 218, 228 and 238, respectively, is randomly chosen, although two packets may each be interfered by an adjacent transmitter, at least one of the three packets is still offset such that it will not be interfered by any of the data packets of one of the other transmitters. This becomes apparent from looking at the intervals of the data packet transmit times. These always differ by at least 100 ms between the different transmitters. Thus, while the starting time of the sequences 218 and 228 is randomly such that the first packet 222 of the second transmitter 120 and the first packet 212 of the first transmitter 210 interfere with each other at the time T₁, and the sequences 228 and 238 are such that the transfers of the data packets 222 and 232 interfere with each other at the time T₂, at least the third packet in the sequence 228 is at the time T₆ such that neither of the transmitters 110 or 130 can also interfere with the same. This applies to arbitrary starting times for all transmitters 110-130.

Finally, the exemplary relative positions of the pattern sequences of the transmitters 110-130 in the case of FIG. 2 result in the fact that an uninterfered reception of the data packet 212 at the receiver 150 is given at the times T₃ and T₇, wherein the data packet 212 arrives uninterfered twice, i.e. at T₃ and T₈, data packet 232 also arrives uninterrupted twice, i.e. at T₄ and T₅, and data packet 222 arrives uninterrupted at least once, i.e. at T₆. The data packets 214, 224 and 234 also arrive uninterrupted at receiver 150 at least once, however, this is not illustrated on the time axis in FIG. 2.

In the above embodiments of FIGS. 1 and 2, the number of transmitted packets per pattern sequence has corresponded to the number of transmitters in the arrangement or the system. The number can however also be higher. This guarantees that the packets of one transmitter are not interfered by the packets of other transmitters despite missing synchronization. Naturally, the number of transmitted packets per pattern sequence can also vary for all transmitters.

Moreover, it is not absolutely necessary that the time intervals between the repeated transfers of one and the same data packet within a pattern sequence are equal to one another, as described above. On the contrary, the time intervals between these repeated transfers could also be different, such as T₃−T₁≠T₇−T₃. In this case, a collision despite missing synchronization between the transmitters 110-130 could be avoided by selecting the pattern sequences such that, independent of the synchronization of the transmitters, between each pair of transmitters not more than one data transfer collides with a data transfer of one of the other transmitters.

It is further understood that the number of three transmitters in the embodiment of FIGS. 1 and 2 is solely exemplary. The present invention will, of course, be applicable and advantageous even if only two or more than three transmitters are used.

In summary, the above embodiment provides a possibility for implementing an access method which can be used when data transfers between several apparatuses, which are always directed to one individual apparatus, are taking place. The nonius method guarantees that the receiving apparatus receives a message from each transmitter within a period without the same being interfered by another transmitter of the system. The transmitting apparatuses do not require a receiving unit and do not have to be time-synchronized. The nonius method is suitable for applications in which the data flow takes place from several transmitters to only one receiver. Through the nonius method, no hardware required for the reception of data is necessary on the transmitter side. The transmitters do not have to be able to detect the occupation status of the channel 140 and it is not necessary to time-synchronize the system apparatuses in order to guarantee that within a transmit window at least one packet of each transmitter reaches the receiver. In FIG. 2, this transmit window in which the receiver 150 receives at least one data packet uninterfered from each transmitter, has had an exemplary length of T_{transmit window}=6 s and is indicated at 248 in FIG. 2.

It is specifically understood that, dependent on the circumstances, the inventive scheme may also be implemented in software. The implementation may be on a digital storage medium, specifically a floppy disc or a CD with electronically readable control signals which can cooperate with a programmable computer system such that the corresponding method will be executed. In general, the invention thus is also applicable in a computer program product with a program code stored on a machine-readable carrier for effecting the inventive method when the computer program product runs on a computer. In other words, the invention can thus be realized in the form of a computer program with a program code for performing the method when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A method for transferring data between at least two transmitters and one receiver, including:
a) repeatedly transferring first identical data from a first one of the transmitters to the receiver in a first sequence; and
b) repeatedly transferring second identical data from a second one of the transmitters to the receiver in a second sequence,
wherein a number of repetitions in the first sequence and a number of repetitions in the second sequence are equal to or greater than the number of transmitters and the first and second sequences are different to each other.

2. The method according to claim 1, further including:
repeating step a) and/or b) for further data so that a total data amount is transferred from the first and/or the second transmitter to the receiver.

3. The method according to claim 1, further including:
repeating step a) for further data with a first repeat period; and
repeating step b) for further data with a second repeat period,
wherein the first repeat period equals the second repeat period.

4. The method according to claim 1, wherein the number of repetitions in the first and second sequences are equal.

5. The method according to claim 1, wherein a period between successive repetitions in the first sequence equals a first period for all successive repetitions, and a period between successive repetitions in the second sequence equals a second period for all successive repetitions, wherein the first and second periods are different to each other.

6. A device for transferring data to a receiver, including:
a first transmitter implemented to transfer first identical data to the receiver in a first sequence; and
a second transmitter implemented to transfer second identical data to the receiver in a second sequence,
wherein a number of repetitions in the first sequence and a number of repetitions in the second sequence are equal to or greater than the number of transmitters and the first and second sequences are different to each other.

7. The device according to claim 6, wherein the first transmitter is implemented to repeat transferring the first identical data for further data and/or the second transmitter is implemented to repeat transferring second identical data for further data in order to transfer a total data amount of from the first and/or the second transmitter to the receiver.

8. The device according to claim 6, wherein the first transmitter is implemented to repeat the transfer for further data with a first repeat period and the second transmitter is implemented to repeat the data transfer for further data with a second repeat period such that the first repeat period equals the second repeat period.

9. The device according to claim 6, wherein the first and second transmitters are implemented such that the number of repetitions in the first and second sequences are equal.

10. The device according to claim 6, wherein the first and second transmitters are implemented such that a period between successive repetitions in the first sequence equals a first period for all successive repetitions, and a period between successive repetitions and the second sequence equals a second period for all successive repetitions, wherein the first and second periods are different to each other.

11. A computer program with a program code for performing the method for transferring data between at least two transmitters and one receiver, when the computer program runs on a computer, the method including a) repeatedly transferring first identical data from a first one of the transmitters to the receiver in a first sequence; and b) repeatedly transferring second identical data from a second one of the transmitters to the receiver in a second sequence, wherein a number of repetitions in the first sequence and a number of repetitions in the second sequence are equal to or greater than the number of transmitters and the first and second sequences are different to each other.
